(19) United States
(12) Patent Application Publication
(10) Pub. No.: US 2022/0054242 A1
(43) Pub. Date: Feb. 24, 2022

(54) SYSTEMS AND METHODS ASSOCIATED WITH A DENTAL DEVICE

(71) Applicant: Longhorn Pediatric Dentistry and Orthodontics, LLC., Austin, TX (US)

(72) Inventors: Reza Arzegar, Austin, TX (US); Deepak Selvaraj, Austin, TX (US); Thompson Bertron, Austin, TX (US)

(21) Appl. No.: 17/100,228

(22) Filed: Nov. 20, 2020

Related U.S. Application Data
(60) Provisional application No. 63/067,420, filed on Aug. 19, 2020.

(51) Int. Cl. A61C 17/22; A46B 9/04; A46B 13/04

(52) U.S. Cl. CPC A61C 17/227; A46B 13/04; A46B 9/04

(57) ABSTRACT

A toothbrush that is configured to emit a solution responsive to a user interaction with the toothbrush.

### BACKGROUND INFORMATION

### Field of the Disclosure

Examples of the present disclosure are related to dental devices. More specifically, embodiments are directed towards a toothbrush that is configured to emit a solution responsive to a user interaction with the toothbrush.

### Background

Proper oral hygiene is paramount in the development and maintenance of a healthy mouth. Dental care consists are regular cleanings to remove plaque and other bacteria that prevents the formation of cavities. Brushing one's teeth is a fundamental technique to perform regular treatments to remove plaque. However, conventional mechanisms for brushing teeth do not accurately and effectively monitor where a person has brushed. As such, a person may unknowingly not brush a certain section of their mouth.

Accordingly, needs exist for dental devices that are configured to dispense a solution within a person's mouth while the person is brushing their teeth, wherein the solution is configured to to effectively and accurately stain locations where the person has brushed their teeth while the person is brushing their teeth.

### SUMMARY

Embodiments disclosed herein describe systems and methods for a dental device that is configured to emit a solution, colloid, substance, etc. (referred to hereinafter collectively and individually as a “solution.”) while a person is brushing their teeth. The solution may be a tracing solution, such as a dye, that is configured to indicate locations where the person has brushed. The dental device may a base, user interface, neck, and head

The base may be a housing that is configured to secure the solution within the dental device. The base may include an inlet, reservoir, and outlet. The inlet may be positioned on a proximal end of the base forming an open proximal end. When the user interface is not coupled with the base, a user may be able to position a solution within the reservoir. The reservoir may be an oval shape with a longer length than width, wherein a volume associated with the reservoir is configured to dynamically change based on a user interacting with the user interface. Responsive to a user interacting with the user interface, the volume associated with the reservoir may decrease causing the solution within the reservoir to flow out of the outlet. The outlet may be positioned on a distal end of the base, and allow fluid to flow from the reservoir into a conduit within the neck.

The user interface may be a device that is configured to change a size of the reservoir, wherein the user interface may be configured to form a first seal on the open proximal end of the base, and a dynamic moveable seal within the reservoir. The user interface may include a knob, puck, and shaft. The knob may be configured to seal the open proximal end of the reservoir, and allow the user to perform actions to change the volume of the reservoir. For example, responsive to a user rotating the knob in a first direction the reservoir may decrease in volume, while rotating the knob in a second direction may cause the reservoir the increase in volume. The shaft may be screw that extends from the knob towards a distal end of the base. The shaft may enable the puck to move between a proximal end of the shaft and a distal end of the shaft based on the user interacting with the knob. The puck may be a device that is configured to move along the shaft to change the size of the reservoir while forming a seal across the reservoir. Responsive to decreasing the size of the reservoir, the puck may move the solution housed within the reservoir to the conduit within the neck.

The neck may be a device that is configured to communicatively couple the head and the base together to allow fluid to flow from the reservoir to the head. More specifically, the neck may include a conduit that is configured to allow the flow of fluid towards a valve within the head. The conduit within the neck may have a smaller cross sectional area than that of the reservoir, and may be positioned close to a rim or outer boundary of the distal end of the reservoir. This may assist in the flow of fluid through the conduit.

The head may be positioned on the distal end of the neck and include bristles, valve, rim, and foam layer. The bristles may be short hairs, fibers, etc. that extend away from a surface of the head, wherein the bristles may be configured to clean plaque from a user's teeth. In embodiments, the bristles may include a first set of bristles and a second set of bristles. The first set of bristles may be standard bristles found on conventional tooth brushes, while the second set of bristles may be replaceable silicon tubes. The silicon tubes may be configured to carry the solution through them and dispense the solution at a distal end of the silicon tubes. In embodiments, the second set of bristles may have a shorter length that the first set of brushes. The valve may be a one way valve that is configured to emit solution from the conduit within the neck onto the user's teeth. In embodiments, the valve may be positioned within a recess on the surface of the head, wherein the recess is larger than the valve. This may enable the fluid to be emitted effectively from the valve. In embodiments, the second set of bristles may be positioned proximate to or on the valve such that the solution may more effectively flow into the silicon tubes. The rim may be a raised lip around the circumference of the surface of the head around the bristles. The rim may act as a barrier to prevent spillage of the solution emitted from the valve. The foam layer may be positioned adjacent to an inner surface of the rim, and extend along the surface of the head to assist in dispersing the emitted solution among the bristles.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a dental device, according to an embodiment.

FIG. 2 depicts a front view of a head of a dental device, according to an embodiment.

FIG. 3 depicts a perspective view of a head of a dental device, according to an embodiment.

FIG. 4 depicts a perspective view of a head of a dental device, according to an embodiment.

FIG. 5 depicts a side view and cross sectional view of a dental device, according to an embodiment.

FIG. 6 depicts a top view of a user interface for a dental device, according to an embodiment.

FIG. 7 illustrates a method for utilizing a utilizing a dental device, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Additionally, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” and “in one embodiment.”

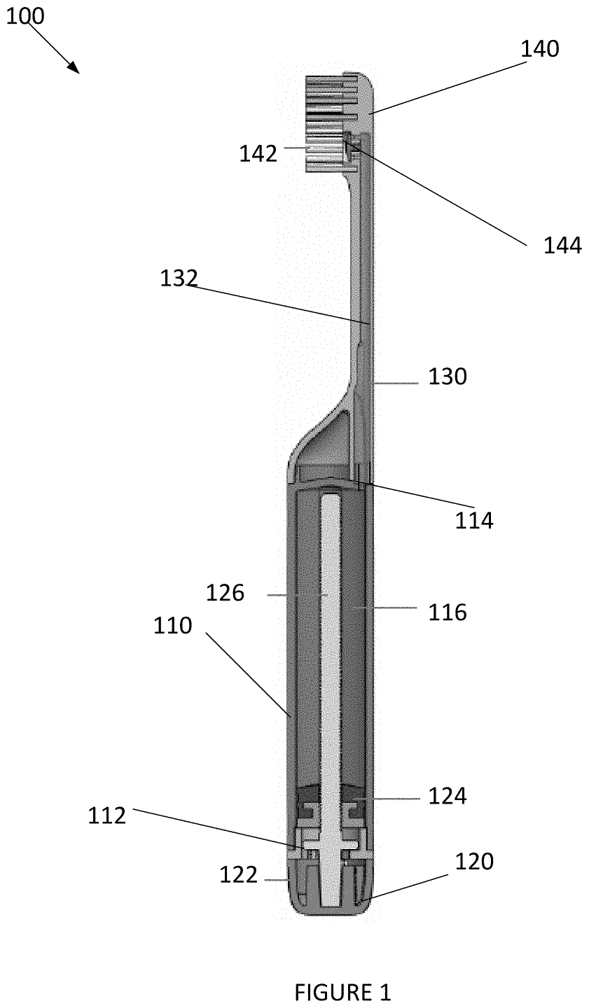

FIG. 1 depicts a dental device 100, according to an embodiment. Dental device 100 may include a base 110, user interface 120, neck 130, and head 140.

Base 110 may be a housing that is configured to secure the solution within the dental device. Base may include an inlet 112, outlet 114, and reservoir 116. Inlet 112 may positioned on a proximal end of base 110, and be configured to allow solution to be positioned within reservoir 116. Inlet 112 may be an open inner end, which may also be configured to allow user interface 120 to be coupled with inlet. Outlet 114 may be positioned on a distal end of base 110, and may be configured to allow fluid to flow between reservoir 116 and conduit 132 within neck. Outlet 114 may have a cross sectional area that is smaller than that of reservoir 116, which may assist in allowing fluid to flow into conduit 132. Reservoir 116 may be positioned between inlet 112 and outlet 114, and may have a larger cross sectional area than that of conduit 132. Reservoir 116 may be an oval shape with a longer length than width, wherein a volume associated with the reservoir is configured to dynamically change based on a user interacting with the user interface 120. Responsive to a user interacting with user interface 120, the volume associated with the reservoir 116 may change. The shrinking of the volume of reservoir 116 may cause solution within reservoir 116 to flow out of the outlet 114.

User interface 120 may be a device that is configured to allow a user to control a volume of reservoir 116 via user interactions, wherein based on the sizing of reservoir 116 solution may be emitted from head 160. User interface 120 may be a button, slide, knob, etc., or any other device that allows a user to perform actions to move a seal within reservoir 116. In embodiments, user interface 120 may include a knob 122, puck 124, and shaft 126.

Knob 122 may be configured to seal the inlet 122, and allow the user to perform actions to change the volume of the reservoir 116. For example, responsive to a user rotating knob 122 in a first direction reservoir 116 may decrease in volume, while rotating knob 122 in a second direction may cause reservoir 116 the increase in volume. Shaft 126 may be screw that extends from knob 122 towards a distal end of the base 110. The shaft 126 may enable the puck 124 to move between a proximal end of the shaft and a distal end of the shaft based on the user interacting with the knob. The puck 124 may be a device that is configured to move along the shaft 126 to change the size of the reservoir while forming a seal across the reservoir 116. Responsive to decreasing the size of the reservoir 116, the puck 124 may move the solution housed within the reservoir to the conduit 132 within neck 130.

Neck 130 may be a device that is configured to communicatively couple head 140 and reservoir 116 within base 110 to allow fluid to flow from the reservoir 116 to head 140. More specifically, neck 130 may include a conduit 132 that is configured to allow the flow of solution towards a valve 142 within head 140. Conduit 132 within the 130 neck may have a smaller cross sectional area than that of reservoir 116, and may be positioned close to a rim or outer boundary of the distal end of the reservoir 160. Furthermore, conduit 132 may have a decreasing cross sectional area from the proximal end of conduit 132 towards the distal end of conduit 132. This may assist in pressurizing the flow of fluid through the conduit 132.

Head 140 may be positioned on the distal end of the neck and include bristles 142 and a valve 144. The bristles 142 may be short hairs, fibers, etc. that extend away from a surface of the head 140, wherein the bristles 142 may be configured to clean plaque from a user's teeth. In embodiments, the bristles 142 may include a first set of bristles and a second set of bristles. The first set of bristles may be standard bristles found on conventional tooth brushes, while the second set of bristles may be replaceable silicon tubes. The silicon tubes may be configured to carry the solution through them and dispense the solution at a distal end of the silicon tubes. In embodiments, the second set of bristles may have a shorter length that the first set of brushes and be positioned proximate to or on the valve 144 such that the solution may more effectively flow into the silicon tubes. The valve 144 may be a one way valve that is configured to emit solution from conduit onto the user's teeth. In alternative embodiments, valve 144 may be an open passageway.

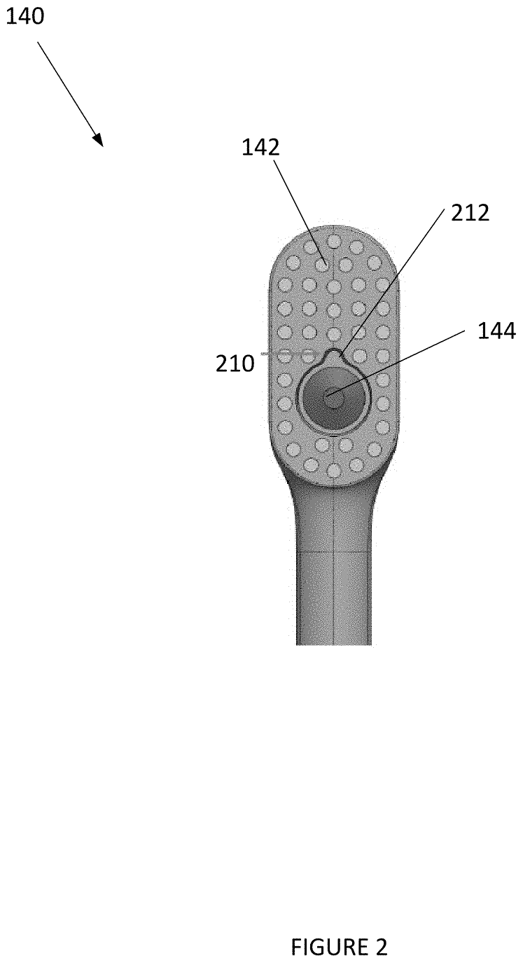

FIG. 2 depicts a front view of head 140, according to an embodiment. Elements depicts in FIG. 2 may be described above, and for the sake of brevity a further description of these items may be omitted.

As depicted in FIG. 2, a front face of head 140 may include a recess 210, wherein valve 144 may be positioned within recess 210. Recess 210 may include a dimple 212 that is configured to increase the surface area of recess 210, such that the rim of recess 210 is not the same shape as valve 144. This may enable the fluid to be emitted effectively from valve 144 by the fluid initially being placed within dimple 212 before being applied to the user's teeth.

Furthermore, recess 210 may be offset from a midpoint of a longitudinal axis of head 140. As such, recess 210 may be positioned closer to a top or bottom of head 142, such that dimple 212 is positioned closer to a midpoint of head 140 than a center of valve 144. This may enable the solution being emitted from valve 144 into dimple 212 being somewhat centrally located.

In further embodiments, a second set of removable bristles may be positioned within recess or over recess. The second set of removable bristles may have a base that is substantially the same shape as that of recess 210 and dimple 212, wherein the base is configured to be overlaid onto recess 210 and dimple 212. The second set of bristles may be silicon tubes with hollow passageways that are configured to allow fluid to flow through the tubes.

In other embodiments, the bristles 142 may be pre-stained with solution before the dental device 100 is packaged.

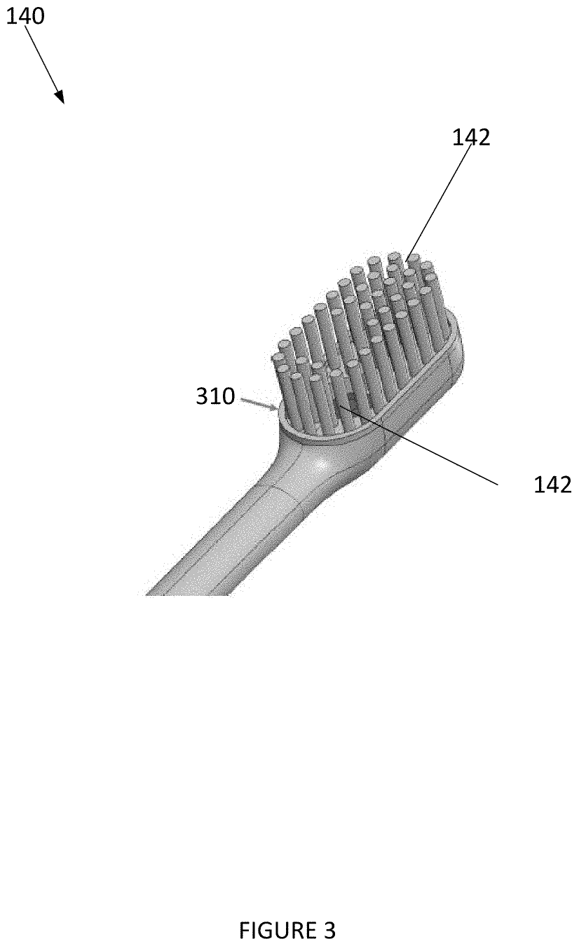

As depicted in FIG. 3, head 140 may include rim 310. Rim 310 may be a raised lip around the circumference of the surface of the head around the bristles 142. Rim 130 may act as a barrier to prevent spillage of the solution emitted from valve 142.

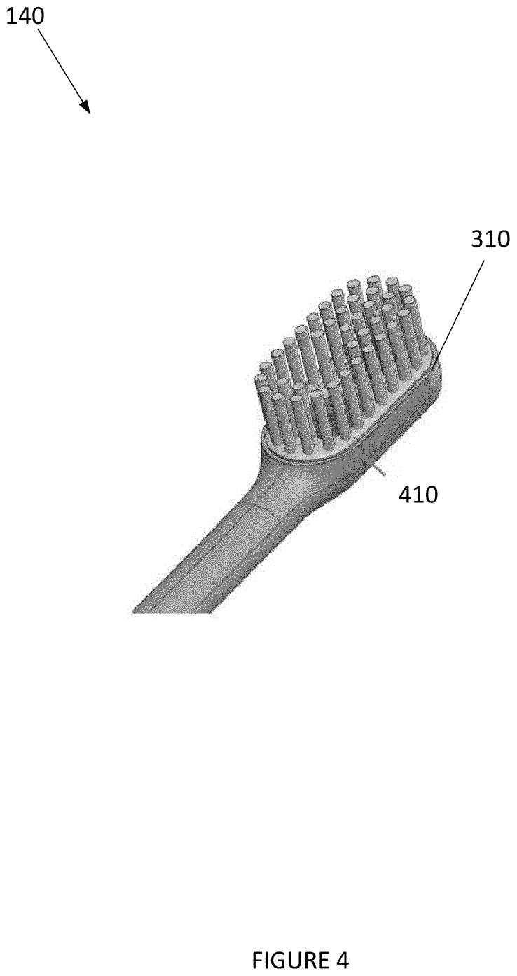

FIG. 4 depicts a perspective view of head 140, according to an embodiment. Elements depicts in FIG. 4 may be described above, and for the sake of brevity a further description of these items may be omitted.

A foam layer 410 may be positioned adjacent to an inner surface of the rim 310, and extend along the surface of the head 140 to assist in dispersing the emitted solution among the bristles.

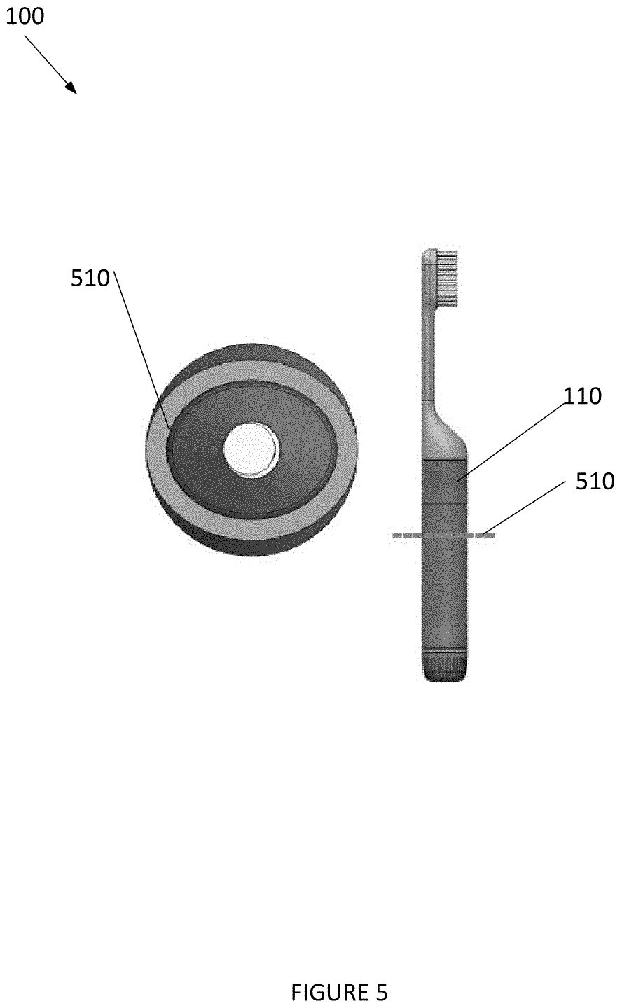

FIG. 5 depicts a side view and cross sectional view of dental device 100, according to an embodiment. Elements depicts in FIG. 5 may be described above, and for the sake of brevity a further description of these items may be omitted.

As depicted in FIG. 5, a cross sectional area of base 110 may be oval 510 in shape. The non-circular cross sectional area of base 110 may prevent the puck within the reservoir from spinning in place, and also ensures that the liquid is dispensed consistently.

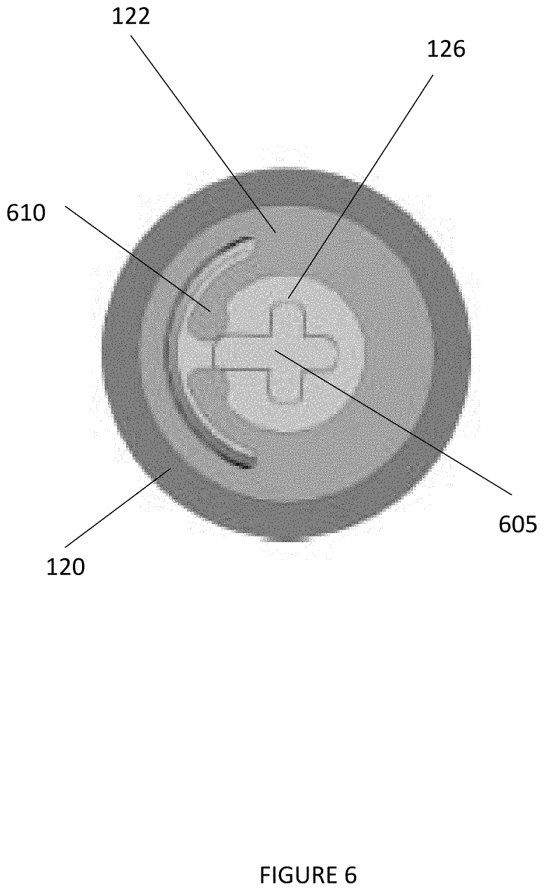

FIG. 6 depicts a top view of user interface 120, according to an embodiment. Elements depicts in FIG. 6 may be described above, and for the sake of brevity a further description of these items may be omitted.

As depicted in FIG. 6, a bottom 605 of shaft 126 may include a series of projections that are configured to interface with stationary arms 610. Responsive to rotating bottom 605, the projection may move from outside of arms 610, continue to rotate a full revolution, and once again be positioned within arms. Responsive to the projection being positioned with the arms, the system may give mechanical feedback to indicate to the user that the puck is being moved along shaft 126.

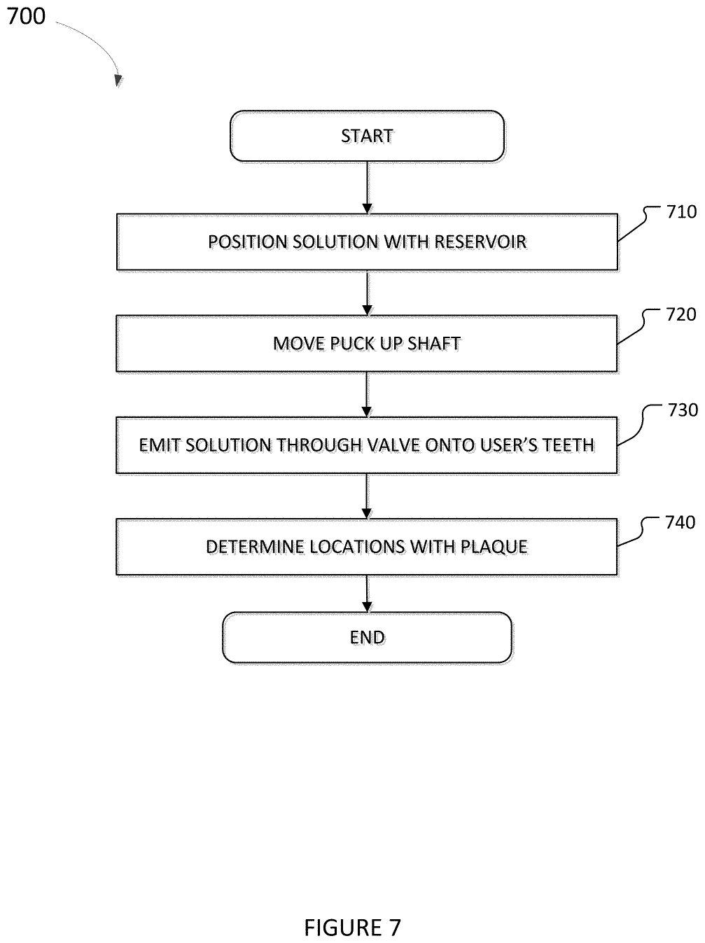

FIG. 7 illustrates a method 700 for utilizing a utilizing a dental device, according to an embodiment. The operations of method 700 presented below are intended to be illustrative. In some embodiments, method 700 may be accomplished with one or more additional operations not described, and/or without one or more of the operations discussed. Additionally, the order in which the operations of method 700 are illustrated in FIG. 7 and described below is not intended to be limiting.

At operation 710, a user may fill a reservoir with solution, such as tracing dye.

Responsive to filling up the reservoir, the user may close an inlet of the reservoir.

At operation 720, the user may interact with a user interface to dynamically change a volume associated with the reservoir. For example, the user may rotate a knob to vertically move a puck along a shaft

At operation 730, responsive to the puck moving along the shaft, the volume of the reservoir may decrease. This decrease in volume of the reservoir may create a pressure increase within the reservoir causing the solution to move past a check valve on a head of the dental device.

At operation 740, the user may use the dental device to emit the solution on the user's teeth, wherein the solution stains plaque on the user's teeth. This will provide a visual assistance to the user for areas of the teeth to brush more effectively.

Reference throughout this specification to “one embodiment”, “an embodiment”, “one example” or “an example” means that a particular feature, structure or characteristic described in connection with the embodiment or example is included in at least one embodiment of the present embodiments. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

The flowcharts and block diagrams in the flow diagrams illustrate the architecture, functionality, and operation of possible implementations of systems, methods, and computer program products according to various embodiments of the present embodiments.

As used herein, the terms “comprises,” “comprising,” “includes,” “including,” “has,” “having,” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A dental device comprising:
a base with a reservoir, the reservoir being configured to house a solution;
a neck with a conduit, the conduit having a proximal end and a distal end, the proximal end of the conduit being in communication with the reservoir;
a head with a recess and a dimple, the distal end of the conduit being configured to supply the solution from the conduit onto the recess, wherein the recess is a depression within a surface of the head, wherein the dimple increases a surface area of the recess.

2. The dental device of claim 1, wherein the dimple is positioned at a midpoint of a longitudinal axis of the head, and the recess is positioned between the dimple and a lower boundary of the head.

3. The dental device of claim 1, further comprising:
a one way valve positioned within the recess, the one way valve being configured to allow fluid to flow onto the recess.

4. The dental device of claim 1, wherein the reservoir has a first cross sectional area that is larger than a variable cross sectional area of the conduit.

5. The dental device of claim 4, wherein the conduit has a decreasing cross sectional area from the proximal end to the distal end of the conduit.

6. The dental device of claim 1, further comprising:
a first set of bristles positioned on the head; and
a second set of removable bristles positioned on the head, the second set of removable bristles being hollow silicon tubes that are shorter than that of the first set of bristles.

7. The dental device of claim 1, further comprising:
a rim positioned around a circumference of the head, the rim extending away from an upper surface of the head.

8. The dental device of claim 7, further comprising:
a foam layer positioned adjacent to an inner surface of the rim, the foam layer having a height that is greater than that of the rim.

9. The dental device of claim 1, further comprising:
a puck configured to move within the reservoir to change a volume of space between the puck and the proximal end of the conduit.

10. The dental device of claim 1, wherein the base includes an inlet, the inlet being configured to allow the solution to be positioned within the reservoir.

11. A method associated with a dental device comprising:
housing a solution within a reservoir of a base
forming a conduit with a proximal end and a distal end, the proximal end of the conduit being in communication with the reservoir;
positioning a head adjacent to the distal end of the conduit, the head having a recess and a dimple;
communicating fluid from the distal end of the conduit onto the recess, wherein the recess is a depression within a surface of the head, wherein the dimple increases a surface area of the recess.

12. The method of claim 11, further comprising:
positioning the dimple at a midpoint of a longitudinal axis of the head; and
positioning the recess between the dimple and a lower boundary of the head.

13. The method of claim 11, further comprising:
positioning a one way valve within the recess, the one way valve being configured to allow fluid to flow onto the recess.

14. The method of claim 11, wherein the reservoir has a first cross sectional area that is larger than a variable cross sectional area of the conduit.

15. The method of claim 14, wherein the conduit has a decreasing cross sectional area from the proximal end to the distal end of the conduit.

16. The method of claim 11, further comprising:
positioning a first set of bristles on the head; and
positioning a second set of removable bristles positioned on the head, the second set of removable bristles being hollow silicon tubes that are shorter than that of the first set of bristles.

17. The method of claim 11, further comprising:
forming a rim around a circumference of the head, the rim extending away from an upper surface of the head.

18. The method of claim 17, further comprising:
positioning a foam layer adjacent to an inner surface of the rim, the foam layer having a height that is greater than that of the rim.

19. The method of claim 11, further comprising:
moving a puck within the reservoir to change a volume of space between the puck and the proximal end of the conduit.

20. The method of claim 11, further comprising:
inserting the solution into the base via an inlet.
